(19) United States
(12) Patent Application Publication
(10) Pub. No.: US 2019/0006051 A1
(43) Pub. Date: Jan. 3, 2019

(54) Ignition system for igniting combustible gas mixtures

(71) Applicant: FRAMATOME GMBH, Erlangen (DE)

(72) Inventor: Axel Hill, Stockstadt (DE)

(21) Appl. No.: 15/999,258

(22) Filed: Aug. 17, 2018

Related U.S. Application Data
(63) Continuation of application No. PCT/EP2017/051513, filed on Jan. 25, 2017.

(30) Foreign Application Priority Data
Feb. 17, 2016 (DE) 10 2016 202 452.3

(51) Int. Cl. G21C 9/06; G21C 19/317; F23Q 3/00

(52) U.S. Cl. CPC G21C 9/06; B01J 35/0006; F23Q 3/004; G21C 19/317

(57) ABSTRACT

An autonomously functioning ignition system, even though it is simple in design, allows for the reliable ignition of combustible gas mixtures that are only slightly above the ignition limit. The ignition system for igniting combustible gas mixtures, particularly in a containment structure of a nuclear facility, includes an electric ignition element and a thermoelectric generator that forms a source of current for the ignition element. A catalytic recombiner for the gas mixture, which is configured as a flow channel for the gas mixture, forms a heat source for the thermoelectric generator.

### CROSS-REFERENCE TO RELATED APPLICATION

This application is a continuation, under 35 U.S.C. § 120, of copending international patent application PCT/EP2017/051513, filed Jan. 25, 2017, which designated the United States; this application also claims the priority, under 35 U.S.C. § 119, of German patent application No. DE 10 2016 202 452.3, filed Feb. 17, 2016; the prior applications are herewith incorporated by reference in their entirety.

### BACKGROUND OF THE INVENTION

### Field of the Invention

The invention relates to an ignition system for igniting combustible gases or gas mixtures. It further relates to a nuclear installation having such an ignition system and also to an associated method.

In the event of a severe accident in a nuclear installation, in particular a nuclear power station, in addition to the release of vapor, large quantities of hydrogen may be released, in particular as a result of the known zirconium/water reaction on overheated fuel rod cladding tubes. Without counter-measures, explosive mixtures (also capable of detonation) which in the event of an uncontrolled reaction endanger the integrity of the safety enclosure which is usually referred to as containment cannot be excluded.

In order to reduce the hydrogen which is released into the containment atmosphere, in particular passive autocatalytic recombiners (PARs) are currently used worldwide. However, recombiners are effective only to a very limited degree within a decisive time period of up to approximately 1 hour after the beginning of the release. In that initial phase, only from 10 to 20% of the released gas quantity which can be recombined is actually catalytically converted. Recombiners consequently under some circumstances cannot prevent explosive mixtures but instead in an unfavorable manner ignite them at a later time. The resultant combustion loads (pressures, missiles) have to be discharged from the containment.

For the limitation of rapid hydrogen releases which can no longer be compensated for by the limited degradation capacity of the recombiners, In particular in U.S. installations electrically operated glow igniters are used. The electrically operated igniters are in this instance primarily operated with emergency power from the diesel network. In the event of a station black-out, the igniters which are supplied by the emergency power diesel unit can no longer be operated and are consequently ineffective with respect to the limitation of transient hydrogen releases.

A retrofitting of additional igniters on the interruption-free emergency power network is as a result of the limited capacity of the battery-assisted emergency power supply often difficult or even impossible. Furthermore, the active electrical glow igniters which are currently used require a relatively large electrical power in order to initiate the ignition (typically >500 Watt).

An igniter which operates on a catalytic basis is described in European published patent application EP 0 596 964 A1. That igniter type requires no external energy supply and directs the ignition by means of heat conduction into a hydrogen-containing gas mixture which has not yet been depleted by the required ignition temperature at the surface of thin platinum ignition threads which protrude into the gas mixture being exceeded. The heat/energy quantity required for this is produced by means of exothermic catalytic hydrogen recombination on a catalyst member and transmitted by means of heat conduction directly onto the ignition threads. However, such a catalytic igniter may initiate an ignition only relatively late after the ignition threshold has been exceeded with a hydrogen proportion between 6 and 10% by volume (depending on the vapor concentration).

The objective is to bring about the ignition of a gentle deflagration as early as possible at small hydrogen concentrations <6% by volume as quickly as possible after the lower ignition threshold has been exceeded so that the combustion loads caused by the reaction remain as small as possible. The earliest possible ignition consequently acts in a safety-related and load-minimizing manner for the structures within the containment and for the actual containment shell.

### SUMMARY OF THE INVENTION

It is accordingly an object of the invention to provide an ignition system and method which overcome the above-mentioned and other disadvantages of the heretofore-known devices and methods of this general type and to provide for an ignition system which functions in the most autonomous manner possible and which with a structure which is kept simple already enables a reliable ignition of combustible gas mixtures slightly above the ignition threshold.

With the foregoing and other objects in view there is provided, in accordance with the invention, an ignition system for igniting combustible gas mixtures containing hydrogen and oxygen in a containment of a nuclear installation, the ignition system comprising:

an electric ignition element being a heating wire or a glow plug;

a thermoelectric generator having a plurality of N-doped and P-doped semi-conductor elements connected in series to form a power source for said ignition element;

a catalytic recombiner for the gas mixture forming a heat source for said thermoelectric generator;

wherein said recombiner is constructed in a flow channel for the gas mixture, and said thermoelectric generator is arranged outside the flow channel for the gas mixture.

In order to introduce a controlled ignition (in the sense of causally predictable, within defined peripheral conditions) at the lowest possible concentrations, there is constructed according to the invention an ignition system which passively produces the energy required for ignition and introduces it into the gas mixture. The passive ignition system contains as a significant element a thermoelectric generator (TEG) or thermogenerator for short.

The TEG elements are connected at the hot side by means of a heat conductor to a heat source. The heat source may be a hot surface (at a temperature, for example, of from 150 to 500° C.), for instance, a pipeline surface of a line which is filled with hot medium or the surface of a container. In a preferred alternative, the heat required to produce electric power is produced by means of a passive catalytic reaction of an autocatalytic recombiner.

The cold side of the TEG is thermally coupled to a heat sink. For example, it is connected to an aluminum member by means of a heat conductor. In this thermally conductive block, a heat pipe is preferably thermally incorporated and preferably discharges the heat via a bundle of heat conduction plates or the like effectively to the environment. Preferably, the heat discharge to the environment is supported by means of natural convection coolers or natural convection.

The TEG produces electrical energy directly from the heat flux. As a result of the heat flux from the heated to the cooled side, in the semi-conductor material of the TEG an electrical voltage is produced as a result of the Seebeck effect. The free electrons in the metal have a higher degree of movability at the warm side and consequently a higher energy than at the colder side. Since each system desires the energetically most favorable state, the electrons move from the warm to the colder side. In this instance, an electrical voltage and with a closed power circuit an electrical current are produced. The TEG consequently passively gains from the applied temperature difference a thermoelectric voltage. The greater the temperature difference, the higher the voltage which a TEG can produce is.

The energy thus produced/converted is used in order, by means of an ignition element, to introduce the required ignition energy into an ignitable gas mixture and to introduce a desired ignition with the lowest possible concentration shortly after the lower ignition limit has been exceeded.

The ignition element may, for example, be constructed as a simple heating wire coil or as a glow plug. If the ignition element is intended to alternatively produce an ignition spark, it comprises the components required for this (such as, for example, capacitors and transistors).

In summary, a significant application field of the invention relates to all reactor types in which during a severe accident hydrogen may be released, for example, by means of a zirconium/water reaction, and which have a containment. This is because, in the event of a configuration-exceeding accident, large quantities of hydrogen may be released into the containment atmosphere. The hydrogen release rate may in this instance be so great that previous hydrogen decomposition measures (for example, by means of PARs) cannot prevent the formation of explosive mixtures with high hydrogen concentrations.

Therefore, with the ignition system according to the invention, the formation of dangerous gas mixtures is intended to be prevented by the concept of early intentional ignition. The passively acting igniters are intended to prematurely ignite the gas mixture in the region of the lower ignition limit. According to the construction and configuration of the igniters, the combustion is carried out as a gentle deflagration. No risk-relevant loads occur for the containment. Releases which could lead to high concentrations with a high potential for risk are already prevented early in their production.

The advantages of the system according to the invention can be summarized as bullet points as follows:
passive production of the ignition energy,
initiation of the ignition shortly after exceeding the ignition limit,
provision of the ignition energy already before the ignition limit has been cxcccdcd,
no expansion of battery capacity necessary when igniters are retrofitted,
compact construction, small component dimensions,
use of a larger number of igniters to cover spaces and volumes is readily possible,
low-maintenance.

Other features which are considered as characteristic for the invention are set forth in the appended claims.

Although the invention is illustrated and described herein as embodied in an ignition system for igniting combustible gas mixtures, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

BRIEF DESCRIPTION OF THE SEVERAL VIEWS OF THE DRAWING

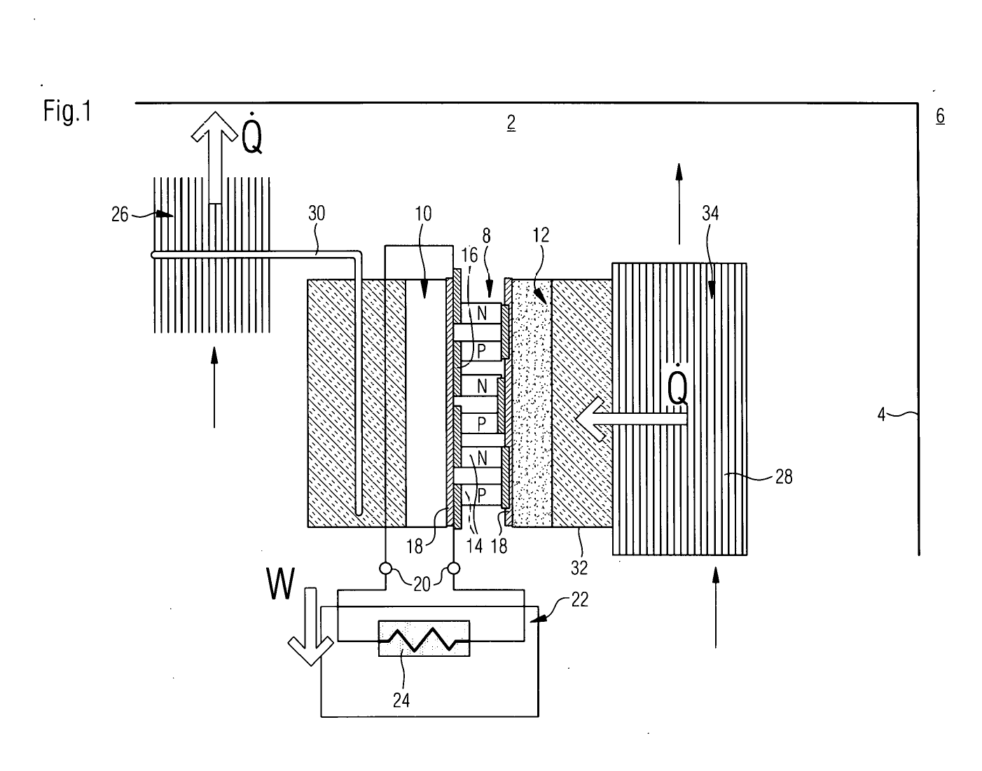

FIG. 1 is a general overview of an ignition system according to the Invention;

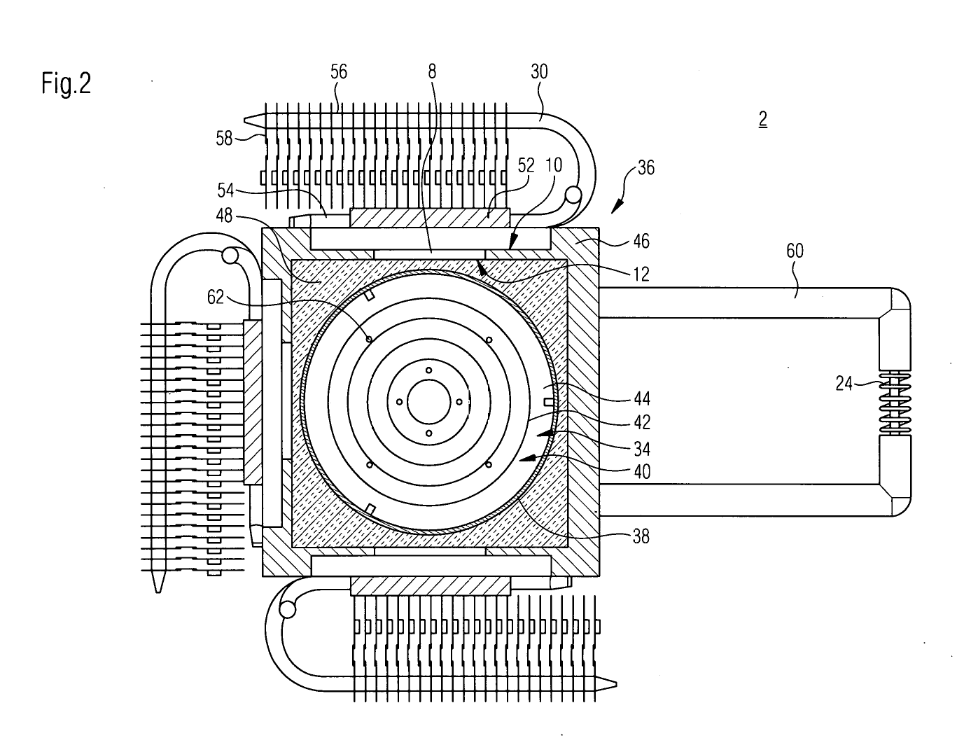

FIG. 2 is a plan view of a first exemplary embodiment (a first variant) of the ignition system according to the invention;

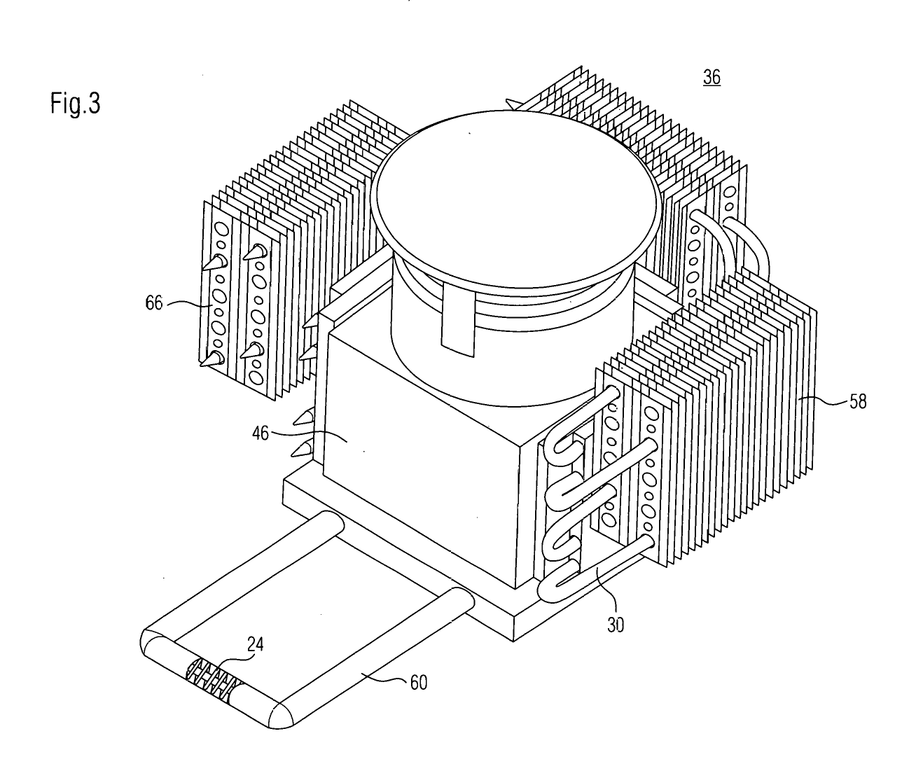

FIG. 3 is a perspective view thereof;

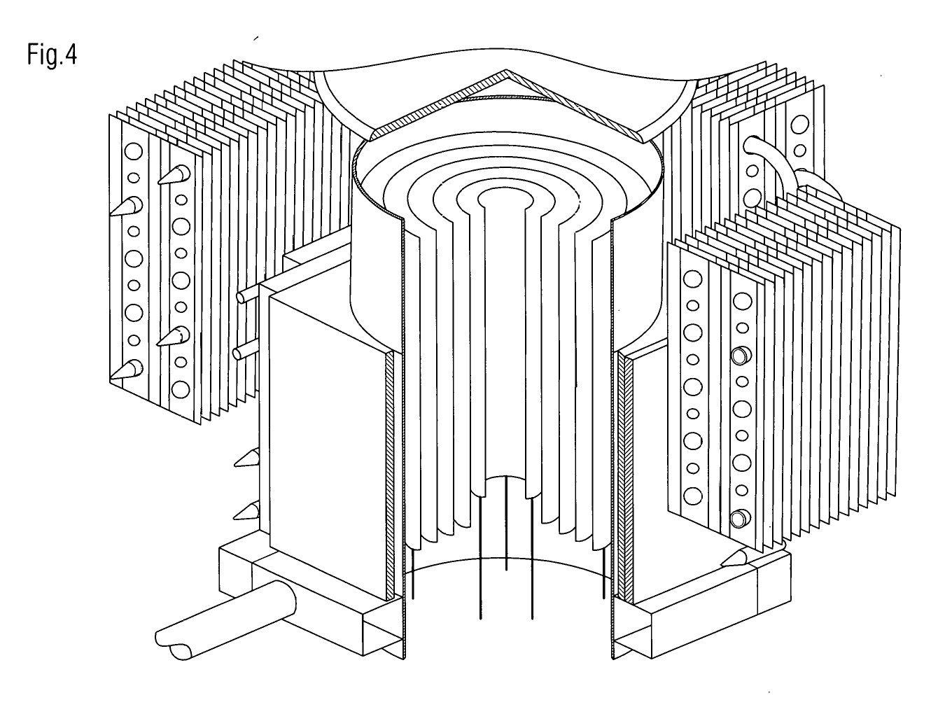

FIG. 4 is a partially sectioned perspective view thereof;

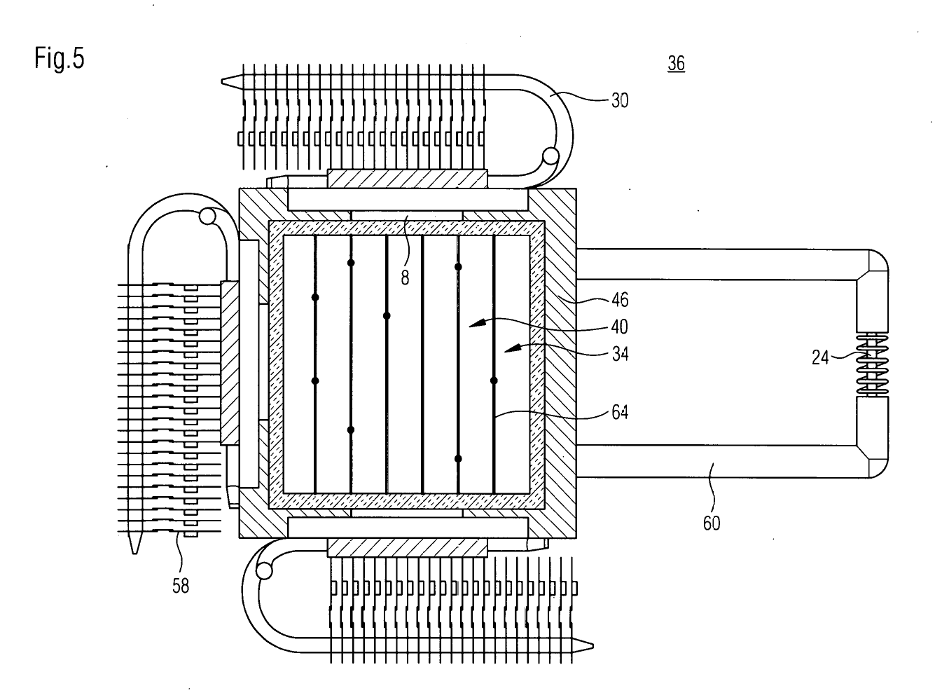

FIG. 5 is a plan view of a second exemplary embodiment (second variant) of the ignition system according to the invention;

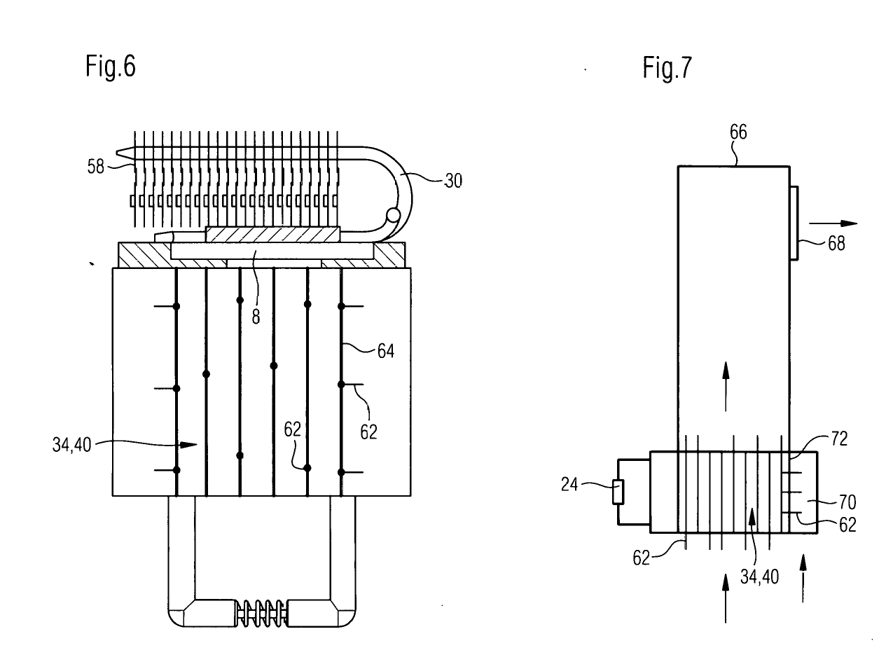

FIG. 6 is a plan view of a third exemplary embodiment (third variant) of the ignition system according to the invention; and

FIG. 7 is a side view (longitudinal section) thereof.

### DETAILED DESCRIPTION OF THE INVENTION

Referring now to the figures of the drawing in detail and first, particularly, to FIG. 1 thereof, there is shown a schematic overview of an ignition system 2 for igniting a combustible gas mixture which can be formed in particular in a containment 4 of a nuclear installation, specifically a nuclear power station 6, in the event of a severe accident.

The ignition system 2 is constructed for autonomous and passive operation and comprises as a significant element a thermoelectric generator (TEG) 8 which in accordance with the Seebeck effect converts a temperature difference or a heat flux between a relatively cold side 10 and a comparatively hot side 12 directly into thermoelectric voltage. The thermoelectric generator 8 comprises for this purpose, for example, a plurality of N-doped and P-doped semiconductor elements 14 which are electrically connected in series and which with junctions 16 located therebetween being formed are arranged between the cold side 10 and the hot side 12. The junctions 16 are in this instance insulated by means of a highly thermally conductive electrical insulation element, for instance, a ceramic layer 18, with respect to the electrically conductive components of the environment.

There are located on the first and on the last semi-conductor element 14 of the series connection electrical connections 20 for tapping the thermoelectric voltage. An ignition current circuit 22 which is connected to the connections 20 contains an ignition element 24 which is arranged with some spacing from the thermoelectric generator 8 in the form of a heating wire, a glow plug or a spark igniter. With a sufficiently high thermoelectric voltage or sufficiently strong current flow (direct current, DC) in the ignition current circuit 22, the ignition element 24 is activated and brings about an ignition in the surrounding gas mixture, assuming that ignitable concentrations are present.

For a high level of effectiveness of the thermoelectric generator 8, the cold side 10 thereof is thermally coupled to a heat sink 26, while the hot side 12 is thermally coupled to a heat source 28. A consistently high temperature difference is thereby ensured.

The heat sink 26 may be located with some spacing from the thermoelectric generator 8, wherein the thermal coupling and heat discharge (discharged heat flux dQ/dt) in this instance are preferably brought about by passive heat pipes 30. The heat source 28 in contrast is preferably located in direct thermal contact with the thermoelectric generator 8 to the greatest possible extent, where applicable with a thermal conductor 32 located therebetween as a connection element.

In a preferred embodiment, the heat source 28 is formed by means of a passive autocatalytic recombiner (PAR) 34 which, for example, recombines hydrogen and oxygen in a surrounding or passing gas mixture in a flameless manner to form water vapor and which becomes heated as a result of the exothermic reaction (supplied heat flux dQ/dt). Alternatively or additionally, for example, a catalytic conversion of carbon monoxide and oxygen to form carbon dioxide may be provided.

A first variant of a specific embodiment of this concept is illustrated in FIGS. 2 to 4. The different components of the ignition system 2 are in this instance combined in a compact arrangement to form a common ignition unit 36.

In the center of the ignition unit 36 is a flow channel 40 which is delimited by a cylindrical pipe wall 38 and which is open in each case at the end side. In the usual installation or assembly situation, the flow channel 40 is oriented vertically and a gas mixture is able to flow through it as a result of the chimney effect produced generally from the bottom to the top. The flow channel 40 is sub-divided by means of cylindrical intermediate walls 42 which are arranged concentrically relative to the center axis into a plurality of annular chambers 44 which can be flowed through in parallel. The intermediate walls 42 and where applicable also the external pipe wall 38 contain in the sense described above catalytically effective surfaces, coatings or zones for the catalysis of the recombination reaction in the gas flow which is directed past, in particular of hydrogen with oxygen.

The geometry of the flow channel 40 and the sub-divisions thereof may in particular be constructed as described in the above-mentioned European published patent application EP 0 596 964 A1. This applies accordingly to the arrangement of optionally provided ignition wires (see further below). The embodiment of the catalysts is preferably carried out by coating a carrier sheet as described in European patent EP 0 923 707 B1 with a palladium strip for the rapid initiation of the catalytic reaction. The disclosures of the two publications are hereby expressly incorporated into the present text.

The heat released during the exothermic recombination reaction serves to heat at least one thermoelectric generator 8 at the hot side 12 thereof. In the present case, the flow channel 40 is surrounded by an in particular square housing 46 which is quadrilateral in cross-section, wherein the intermediate spaces between the outer side of the pipe wall 38 and the inner side of the housing 46 are filled with a highly thermally conductive filling material 48. For example, thermoelectric generators 8 are mounted at three of the four lateral outer faces of the parallelepipedal housing 46. Each of the thermoelectric generators 8 has in the example shown here a flat plate-like outline, wherein the inner base face which is active as the hot side 12 faces the filling material 48 and is connected thereto in a highly thermally conductive manner. To this end, the housing 46 is provided with suitable apertures. The outer base face which acts as a cold side 10 faces away from the housing 46.

In order to improve the cooling and the heat discharge from the cold side 10 of the respective thermoelectric generator 8, one or more heat pipes 30 are thermally coupled to the cold side 10, in this instance by means of a highly thermally conductive connection plate 52, for example, of aluminum (with respect to the heat pipe 30, the “cold side” 10 of the thermoelectric generator 8 is intended to be understood to be a heat source). The respective heat pipe 30 has a U-shaped structure, wherein one of the two legs 54 is in abutment with the connection plate 52 or directly with the cold side 10 of the thermoelectric generator 8, and the other leg 56 leads away from the housing 46 or as shown here extends with some spacing parallel therewith. The respective heat pipe 30 contains a heat transport medium which preferably circulates in a natural circuit between the relatively hot leg 54 which acts as an evaporator for the heat transport medium and the relatively cold leg 56 which acts as a capacitor. On the latter there is a heat discharge to the environment. A grid which surrounds the heat pipes 30 of thermally conductive sheets 58 (cooling ribs) optimizes the heat transfer to the surrounding atmosphere.

In place of heat pipes which are driven by gravitational force and/or driven by means of capillary action with a two-phase cooling circuit, it is also possible to use heat pipes which have a single-phase cooling circuit (a pure thermosiphon) but which are not so effective with regard to the heat transport.

Carrier arms 60 which are mounted laterally on the housing 46 and which protrude outward retain with some spacing from the housing 46 an ignition element 24, for example, in the form of a heating wire, a glow plug or a spark igniter. The conductors or cables of the associated electrical connection line advantageously extend within the carrier arms 60 which are constructed as casing pipes. The thermoelectric generators 8 may be connected electrically in series or in parallel depending on requirements with respect to the thermoelectric voltage produced by them.

As soon as a gas mixture which is capable of recombination flows through the flow channel 40, the exothermic recombination combination begins in the catalytically active zones of the recombiner 34 and begins the production of the thermoelectric voltage in the thermoelectric generator 8. The required ignition energy for igniting the gas mixture can consequently already be produced before reaching the lower ignition limit so that the ignition by the ignition element 24 can then be carried out directly after this limit has been exceeded.

Typically, the thermoelectric generators 8 produce an electric power of from 5 to 200 W, by means of which an ignition wire/heating coil of the ignition element 24 is brought to ignition temperature (typically >500° C.) or alternatively a spark igniter is supplied.

Furthermore, the catalytic recombiner 34 may also be active itself as an igniter for the gas mixture. This is particularly the case when, as a result of (large volume, global) transient gas displacement processes within the environment or as a result of extremely rapid releases of ignitable gas mixtures, there is produced a sudden massive flow which heats the surface of the catalytically active zones to high temperatures (typically >500° C.). In order to support this alternative ignition mechanism, ignition wires 62 may be present and are connected at one end to the catalytically active zones and are heated by them to ignition temperature and at the other end protrude into the flow channel 40. With respect to the details in relation to this ignition mechanism, reference may be made to the above-mentioned publication EP 0 596 964 A1.

The variant of the ignition system 2 illustrated in FIG. 5 differs from the previously described variant only in terms of the geometry of the flow channel 40 which in this instance has a rectangular cross-section and is sub-divided by a plurality of flat plates 64 with a catalytic coating or catalytic zones into parallelepipedal part-channels.

Such a rectangular geometry is also present in the variant illustrated in FIGS. 6 and 7. A convection housing 66 which protrudes beyond the housing 46 with an outlet 68 which is arranged at the upper end supports the desired natural draught of the chimney-like arrangement (a similar chimney pot, but not quite so high, can also be seen in FIGS. 3 and 4).

In addition to the first flow channel 40 which is active as a recombiner 34 and in which the flowing gas mixture is reduced or depleted in terms of the concentration. of the ignitable components thereof, there is located in parallel arrangement a second flow channel 70 (convection channel) which is separated in terms of flow from the first flow channel 40 without recombiner elements in which no depletion of the convection flow is carried out. Through apertures of the intermediate wall 72, ignition wires 62 of the first flow channel 40 are guided into the second flow channel 70. These ignition wires 62 are heated by the catalytic zones in the first flow channel 40 and direct, in the context of the earliest possible ignition, the ignition energy into the second flow channel 70, where the gas flow can be more readily ignited as a result of the lacking depletion.

The following is a summary list of reference numerals and the corresponding structure used in the above description of the invention:

2 Ignition system

4 Containment

6 Nuclear power station

8 Thermoelectric generator

10 Cold side

12 Hot side

14 Semi-conductor element

16 Junction

18 Ceramic layer

20 Connection

22 Ignition power circuit

24 Ignition element

26 Heat sink

28 Heat source

30 Heat pipe

32 Thermal conductor

34 Catalytic recombiner

36 Ignition unit

38 Pipe wall

40 Flow channel

42 Intermediate wall

44 Annular chamber

46 Housing

48 Filling material

52 Connection plate

54 Leg

56 Leg

58 Thermally conductive sheet

60 Carrier arm

62 Ignition wire

64 Plate

66 Convection housing

68 Outlet

70 Flow channel

72 Intermediate wall

1. An ignition system for igniting a combustible gas mixture containing hydrogen and oxygen in a containment of a nuclear installation, the ignition system comprising:
an electric ignition element being a heating wire or a glow plug;
a thermoelectric generator having a plurality of N-doped and P-doped semi-conductor elements connected in series to form a power source for said ignition element;
a catalytic recombiner for the gas mixture forming a heat source for said thermoelectric generator;
wherein said recombiner is constructed in a flow channel for the gas mixture, and said thermoelectric generator is arranged outside the flow channel for the gas mixture.

2. The ignition system according to claim 1, wherein the flow channel is configured for conducting a natural draught of the gas mixture.

3. The ignition system according to claim 1, further comprising a heat pipe for discharging heat from said thermoelectric generator.

4. The ignition system according to claim 1, wherein said recombiner comprises ignition wires to be activated by way of reaction heat for igniting the gas mixture.

5. A nuclear installation, comprising a containment and an ignition system according to claim 1 disposed in said containment.

6. The nuclear installation according to claim 5 configured as a nuclear power station.
